(19) United States
(12) Patent Application Publication
(10) Pub. No.: US 2009/0016849 A1
(43) Pub. Date: Jan. 15, 2009

(54) Landscape retaining stake

(75) Inventors: Thomas S. Riccobene, Albuquerque, NM (US); Merlyn D. Nyght, Albuquerque, NM (US)

Correspondence Address: GREER, BURNS & CRAIN, 300 S WACKER DR, 25TH FLOOR, CHICAGO, IL, 60606, US

(73) Assignee: Riccobene Designs LLC

(21) Appl. No.: 11/827,888

(22) Filed: Jul. 13, 2007

(51) Int. Cl. F16B 15/00; E02D 27/01

(52) U.S. Cl. 411/496; 411/487; 52/102

(57) ABSTRACT

A stake for securing stones, pavers, bricks and other landscape units comprises an elongate body having an upper end including an anvil surface and an abutment, a chisel shaped lower end, a front face, and a rear face that is inclined rearwardly relative to the front face of the body from the lower end of the body to the upper end of the body to form a wedge. When the stake is aligned with a stone and is driven into the ground, it pivots underneath the stone, and the abutment engages a lower edge of the stone to restrain shifting of the stone laterally and sinking of the stone vertically.

### FIELD OF THE INVENTION

The present invention relates to devices, particularly stakes, for retaining in place pavers, bricks and landscape stones employed in outdoor patios, walkways, flowerbed borders and other landscape settings.

### BACKGROUND

Outdoor patios, driveways and walkways are frequently formed by placing landscape stones on a bed of sand or gravel. Typically, no cementitious or other binding material is employed to lock the stones in place. Consequently, there is a tendency for the stones to migrate laterally, to shift and sink, and to fall into disarray, leaving an unsightly and potentially dangerous walking surface rather than the smooth and attractive surface originally intended. Similarly, stones are employed for flowerbed and lawn borders and edgings and the like have a tendency to shift and fall into disarray.

Many systems have been proposed for retaining the marginal edge elements of such patios, walkways and edgings in place, thereby to constrain all of the stones in the patio or walkway against movement. In some cases, cementitious material is used to retain the borders. In other cases, devices are used to retain the borders. These devices have ranged from simple stakes or spikes driven into the ground contiguous to the marginal stones to plural element edging systems comprised of complex edging strips and securing spikes. Stakes have a tendency to migrate away from the edge of the stone(s) and thereby fail to provide lateral support. Edging strips can be used when the border is a straight line or a smooth curve. However, edging strips cannot be used when the border is irregular, as is the case with natural (or artificial) stone patios, walkways, etcetera. Many retaining systems are designed to provide lateral retention, but fail to provide vertical retention to prevent the marginal edges from “sinking.”

Prior art landscape retaining systems thus have met with varying degrees of success and failure. As always, there is considerable room for improvement.

### SUMMARY OF THE INVENTION

In accordance with the invention, an improved landscape unit or stone retaining stake is provided. Herein the term “stone” means natural stone and manufactured landscape stones, pavers, bricks and the like. “Landscape units” refers to stones as well as other landscape elements, such as railroad ties. For convenience throughout the application reference is made to stones, but it is to be understood that such is equally applicable to other landscape units.

The retaining stake of the invention is comprised of an elongate, preferably unitary, rigid body having a front or forward surface, a back or rear face, a lower tapered end and an upper end or head. The lower tapered end is preferably chisel shaped and includes an alignment surface for engagement with the side of a stone at the inception of installation as a guide for correctly positioning the stake for entry into the ground in stone retaining position.

The front face of the body is adapted for sliding contact with the stone and forms a fulcrum about which the body is adapted to pivot. The rear face is inclined rearwardly from bottom to top to form a wedge. As the stake is driven into the ground the wedge urges the stake laterally towards the stone reducing a common problem of stakes migrating away from the stone while being driven. The wedge also causes the body of the stake to pivot about the lower edge of the stone so that the lower end of the body moves in under the stone as the stake is driven into the ground.

The head includes an anvil, impact or striking surface that is generally perpendicular to the front face of the body, and an abutment projecting forwardly from the anvil surface beyond the front face of the body. The anvil surface is preferably located so that impact or blows imparted to the same define a line of applied force extending longitudinally of the body and preferably offset rearwardly from the center line of the body. This eccentric loading contributes in causing the body to pivot or turn under the stone as the body is driven into the ground. The abutment has a forwardly facing stone restraining abutment surface that is brought into engagement with the side of the stone when the body is driven fully into the ground. The front face of the body at or near the juncture of the abutment surface is adapted to engage the base edge of the stone. The abutment surface and front face engage and support the stone both horizontally, to prevent lateral movement, and vertically, to prevent sinking. Additionally, the abutment spaces the anvil or striking surface laterally away from the stone, thereby mitigating damage to the stone from inadvertent hammer blows.

The landscape retaining stake of the invention thus provides a very economical, practical and effective stone support system. The retaining stakes of the invention can be used to secure individual stones as well as entire surfaces, such as patios, walkways and driveways. The invention does not require use of an edging strip. Thus, it can be used to secure surfaces with irregular marginal edges, as shown for example in commonly owned U.S. Pat. No. 6,881,463, as well as surfaces with straight and smoothly curved edges. These and other advantages of the invention will become apparent to those of reasonable skill in the art from the following detailed description, as considered in conjunction with the accompanying drawings.

### BRIEF DESCRIPTION OF THE DRAWINGS

FIG. 1 is a perspective view of a presently preferred embodiment of the landscape retaining stake of the invention;

FIG. 2 is a side view of the landscape retaining stake illustrated in FIG. 1;

FIGS. 3-6 are elevational views illustrating in sequence the steps involved in installing the landscape retaining stake of FIG. 1 contiguous to and in retaining relationship with a stone.

### DETAILED DESCRIPTION OF A PREFERRED EMBODIMENT

The following is a description of an embodiment of the invention presently contemplated by the inventors to be the best mode of carrying out their invention.

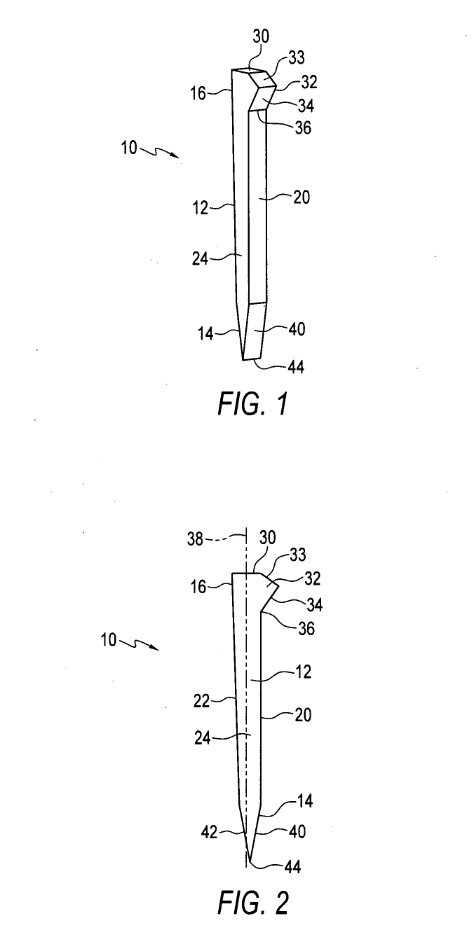

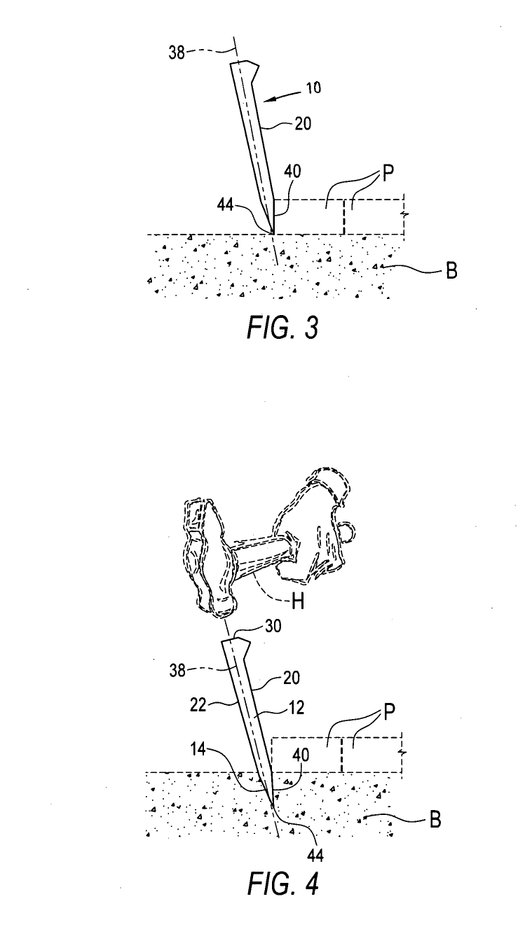

Referring to the drawings, particularly FIGS. 1 and 2, the landscape retaining stake of the invention, indicated generally at 10, is comprised of an elongate body 12 having a tapered lower end 14 and an upper end or head 16. The cross-sectional shape of body 12 is shown as being essentially square, but could be other shapes such as H-shape. The lower tapered end is preferably chisel-shaped. The stake may be made of any rigid, sturdy and long lasting material, such as metal, plastic and preservative treated wood.

The length and cross-section of the body 12 may be sized according to the demands of the particular application for which the stake is intended. For conventional garden, footpath and patio applications, a recommended cross-section is in the order of ¾ inch by ¾ inch and a recommended length is about 8 to 12 inches. The body has a front or forward face 20, a back or rear face 22, and parallel side faces 24. The back face 22 is inclined upwardly and rearwardly relative to the forward face 20.

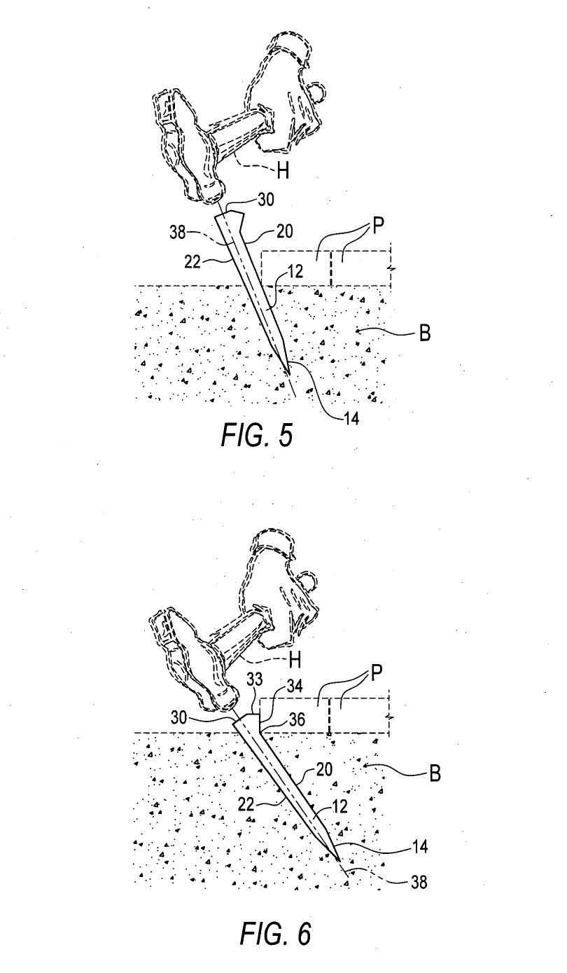

The head 16 of the stake is comprised of a generally flat anvil or striking surface 30 and a forwardly projecting abutment 32 having a stone abutting surface 34 and a stone edge receiving notch 36. Force supplied by a hammer or sledge to the surface 30 of the head (as depicted in FIGS. 3-6) will be transmitted along a line of force (indicated by dot dash line 38) extending generally normal or perpendicular to the flat surface 30 of the anvil. The anvil is preferably so located that the line of force 38 is offset rearwardly from the center line of the body 12, as is more fully explained below.

The front face 20 of the stake body 12 is preferably generally parallel to the line 38 of applied force. The back or rear face 22, on the other hand, is inclined rearwardly from bottom to top at an angle from about 0.1 degrees to about 5.0 degrees relative to line parallel to the line of force. A most preferably angle is about 2.4 degrees, which results in about a one-quarter inch wedge for an 8 inch stake.

The tapered lower end 14 of the body 12 is preferably chisel shaped with inclined front and rear faces 40 and 42 respectively, which join to form a knife edge 44 at the lower end or bottom of the stake to facilitate entry of the stake into the ground. The face 40 is inclined at an angle from about 8 to about 30 degrees relative to a line parallel to the line of force. Preferably, the back face is inclined at about the same, albeit reverse, angle such that the edge 44 is approximately laterally centered in the lower end of the stake. The lateral location of edge 44 will affect the degree of rotation of the stake as it is driven into the ground. The degree of rotation will be increased the greater the lateral distance between edge 44 and line of force 38. It is preferred that edge 44 is located laterally at or forwardly spaced from the line of force, and it is most preferred that edge 44 is at the lateral midpoint of the lower end 14 offset forwardly from the line of applied force 38, as shown in FIG. 2.

The abutment surface 34 is preferably set at an angle such that it will be flush with the side of stone P when fully installed (see FIG. 6). More specifically, surface 34 is preferably inclined at an angle of about 5 to about 10 degrees greater than lower end front face 40, relative to a line parallel to the line of force 38, for reasons that will become clear from the installation method described below. The abutment top surface 33 is preferably set an angle of approximately 90 degrees relative to the abutment surface 34. The top surface is of sufficient length, preferably about ¾ inch, to space the anvil surface away from the stone during installation.

The method of installing the stone stake of the invention contiguous to a stone or other landscape unit in a garden, patio or walkway is illustrated in FIGS. 3-6. As is conventional for a patio or walkway, a plurality of stones P are set contiguous to one another in a select pattern on a bed B of sand or gravel. Unless the stones at the border of the patio or are constrained against movement, the stones will migrate laterally and fall into disarray, leaving an unsightly and potentially dangerous walking surface rather than the smooth attractive surface intended. The stake of the invention prevents this from happening.

As illustrated in FIG. 3, the stake 10 is initially positioned generally upright, with its front or forward surface 20 facing the marginal edge of a stone P, the knife edge 44 of the lower end 14 engaging the ground contiguous to the base edge of the stone and the front face 40 of the lower end 14 engaged substantially flush against the marginal side surface of the stone P such that the upper end is tilted rearwardly. The slope of the forward inclined face 40 of the lower end 14 is significant as this surface is employed as an alignment guide for properly setting the initial entry angle of the stake as the first step in the installation process. As plural stakes are driven into place, the installer may wish to modify the initial entry angle departing slightly from the flush relationship between the front face 40 and the side of the stone P. In any event, face 40 operates as an alignment guide.

With the stake thus aligned with the stone, several strokes or blows applied with a hammer, sledge or like implement H to the anvil or striking surface 30 of the stake commences driving the knife edge 44 of the chisel into the ground while maintaining the front face 40 of the lower end in engagement with the edge of the stone as depicted in FIG. 4. As with any stake, spike or nail, it is important to squarely strike the head 30 when driving the stake.

When the face 40 of the lower end 14 clears (passes below) the base edge of the stone P, the front face 20 of body 12 engages the base or lower edge of the stone. Due to the wedging force that is produced by the inclined rear or back surface 22 of the body 12, the body is urged laterally towards the stone to maintain engagement of front face 20 with the stone. Further, the combination of the wedging force and the rearward offset of the line of force applied by the hammer to the anvil causes the stake to pivot or turn using the base edge of the stone P as a fulcrum, such that the lower end 14 of the body moves in under the stone. The amount of rotation that occurs depends on a variety of factors including the specific geometry of the stake, and the composition and moisture content of the bed. Rotation of about 5 to about 10 degrees has been observed in installations of the stake shown and described in this preferred embodiment in sand and/or gravel beds. Consequently, with continued hammering on the anvil 30, the body 12 burrows into the bed B underneath the stone as is illustrated in FIGS. 5 and 6.

With the final few blows of the hammer on the anvil, as illustrated in FIG. 6, the abutment surface 34 on the head 16 is moved into engagement with the side surface of the stone to restrain lateral movement or displacement of the stone. In addition, front face 20 at notch 36 engages the base edge of the stone to prevent sinking or falling of the marginal edge portion of the stone. Most preferably, as shown in FIG. 6, the abutment surface 34 is flush with the side of the stone, and the notch 36 is in mating engagement with the base edge of the stone. It is nevertheless acceptable if the stake has been driven to a final angle that slightly off the most preferred angle shown in FIG. 6. If the angle is too shallow, the notch 36 will nevertheless engage the base edge of the stone, retaining the stone laterally and vertically. On the other hand, if the angle is too steep, the top edge of the abutment surface will engage the side of the stone, and the front face 20 will engage the base edge of the stone, thus providing both horizontal and vertical retention.

As appears in FIG. 6, the abutment 32 spaces the anvil 30 laterally away from the stone so as to mitigate inadvertent hammer blows and consequent damage to the stone. When fully installed, the abutment top surface 33 is generally parallel to the ground and the anvil 30 forms a desirable chamfer with the ground.

The landscape retaining stake of the invention thus provides, in a unitary and easily installed article a system for securely retaining garden, patio and walkway stones and landscape units in place and for mitigating against lateral displacement, shifting and sinking of the units.

While a preferred embodiment of the landscape retaining stake of the invention has been herein illustrated and described, it is to be appreciated the various changes, rearrangements and modifications may be made therein without departing from the scope of the invention as defined by the appended claims.

1-20. (canceled)

21. A retaining stake, comprising:
an elongate body having an upper end, a lower end, a front side, and a rear side;
an anvil surface on the upper end of said body generally perpendicular to said body, and defining a line of force extending longitudinally of said body and being normal to said anvil surface;
a front face on the front side of said body being generally parallel to said line of force; and
a rear face on the rear side of said body being inclined rearwardly from said line of force from the lower end to the upper end and defining a wedge only on the rear side of said stake.

22. A retaining stake as set forth in claim 21, said rear face of said body being inclined at an angle from about 0.1 degree to about five degrees relative to the line of force.

23. A retaining stake as set forth in claim 21 for retaining a landscape unit, wherein said upper end comprises an abutment only on the front side of said body, said abutment having a top face inclined forwardly and downwardly from said anvil surface and an abutment surface inclined downwardly and rearwardly from the top face, the abutment surface being adapted to engage the side of the landscape unit to restrain lateral movement of the unit.

24. A retaining stake as set for the in claim 23, wherein the abutment surface and the front face of the body meet to define a notch, and wherein the front face is adapted to engage a lower edge of the landscape unit at or adjacent the notch for retaining the unit against vertical sinking when the body is driven fully into the ground.

25. A retaining stake as set forth in claim 21 for retaining a landscape unit, wherein the front face of the body is adapted to engage a lower edge of the landscape unit when the body is driven fully into the ground to restrain vertical sinking of the unit.

26. A retaining stake as set forth in claim 21 for retaining a landscape unit, further comprising an abutment having a top face inclined forwardly and downwardly from said anvil surface to offset said anvil surface rewardly and adapted to space said anvil surface away from the edge of the landscape unit when said body is being driven into the ground.

27. A retaining stake as set forth in claim 21, wherein said lower end is chisel shaped, comprising a front chisel face inclined rearwardly from the front face of the body and being adapted for use as an alignment guide.

28. A retaining stake as set forth in claim 27, said front chisel face being inclined at an angle of from about 8 degrees to about 30 degrees relative to the line of applied force.

29. A retaining stake as set forth in claim 21, wherein the lower end of the body is chisel shaped comprising a front face inclined rearwardly and downwardly from the front face of said body and a rear face inclined forwardly and downwardly from the rear face of said body, defining a knife edge at the lower end of the body offset forwardly from said line of force.

30. A retaining stake as in claim 21 wherein said line of force is eccentrically offset rewardly from a center line of said body.

31. A retaining stake, comprising:
an elongate body having an upper end, a lower end, a front face, and a rear face, said body having a center line;
an anvil surface on the upper end being generally perpendicular to said body, and defining a line of force extending longitudinally of said body, normal to said anvil surface, and offset rearwardly from the center line of said body; and
a chisel shaped edge at the lower end of said body, said edge being at or offset forwardly from said line of force.

32. A retaining stake as set forth in claim 31, further comprising an abutment on the upper end of said body having a top surface inclined forwardly and downwardly from said anvil surface and adapted to offset said anvil surface rewardly relative to said front face.

33. A retaining stake for retaining a landscape unit as in claim 32 wherein said abutment further comprises a surface inclined downwardly and rearwardly from the abutment top surface and being adapted to engage a side of the landscape unit to restrain lateral movement and said front face of said body being adapted to engage a base edge of the landscape unit to restrain vertical movement.

34. A retaining stake as in claim 31 wherein said chisel edge is substantially laterally centered at the lower end of said body.

35. A retaining stake, comprising:
an elongate body having an upper end and a lower end;
an anvil surface on said upper end generally perpendicular to the body, and defining a line of force extending longitudinally of said body and being normal to said anvil surface;
a front face generally parallel to said line of force;
a rear face inclined rearwardly from said lower end to said upper end relative to said line of force; and
an abutment only on one side of said upper end, said abutment having a top face inclined forwardly and downwardly from said anvil surface and a bottom face inclined downwardly and rearwardly from the top face to the front face of said body.

36. A retaining stake as set forth in claim 35, wherein said body has a centerline and said line of force is offset rearwardly from the center line of said body.

37. A retaining stake as in claim 35 wherein the chisel edge is substantially on the centerline of said body.

38. A retaining stake as set forth in claim 35, wherein the rear face of said body is inclined at an angle of from about 0.1 degree to about 5 degrees relative to said line of force.

39. A process for retaining a landscape unit comprising the steps of
providing a stake comprising an elongate body having an upper end, a lower end, a front and a rear face, a head on the upper end of the body and a taper on the lower end of the body, said head having an anvil surface generally perpendicular to the front face of the body and including an abutment projecting forwardly of the front face of the body, the rear face of the body being inclined rearwardly relative to the front face of the body from the lower end of the body to the upper end of the body to define a wedge on the rear side of the body, said taper on the lower end having an alignment surface inclined rearwardly from the front face of the body;
engaging the alignment surface of the tapered end of the stake with an exposed side of the landscape unit and pressing the lower end of the tapered end against the ground;
repeatedly striking the anvil surface of the body with an implement and driving the body down into the ground;
maintaining the front face of the body in engagement with a lower edge of the landscape unit by operation of the wedge;
continuing to strike the anvil surface causing the body, due to the wedge and the force applied to the anvil surface, to rotate under the landscape unit; and
continuing to strike the anvil surface until said abutment engages the side of the landscape unit with the front face of said body engaging the lower edge of the unit.

40. A process as set forth in claim 39 wherein the abutment spaces the anvil surface laterally from the landscape unit.
